(19) United States
(12) Patent Application Publication
(10) Pub. No.: US 2003/0080201 A1
(43) Pub. Date: May 1, 2003

(54) Injection device and method for injection of fluids

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,242

(22) PCT Filed: Jan. 13, 2001
(86) PCT No.: PCT/DE01/00123

(51) Int. Cl. B29C 45/20

(52) U.S. Cl. 239/87

(57) ABSTRACT

The invention relates to an injection device with an injector, a control valve (26) for opening and closing the injector by means of a control chamber (32), and an actuating element (14) for actuating the control valve (26), wherein at least one additional first valve (22) and one additional second valve (24) are provided, the additional first valve (22) can introduce a primary pressure into a pressure chamber (34) of the injector and into the control chamber (32), the additional second valve (24) can connect the pressure chamber (34) of the injector and the control chamber (32) to a leakage system (36), and the control valve (26), the additional first valve (22), and the additional second valve (24) can be actuated by the same actuating element (14). The invention also relates to a method for injecting fluid, which uses the injection device according to the invention.

### PRIOR ART

The invention relates to an injection device with an injector, a control valve for opening and closing the injector by means of a control chamber, and an actuating element for actuating the control valve. The invention also relates to a method for injecting fuel in which an actuating element is activated, the actuating element actuates a control valve, a control chamber is pressure-relieved through the actuation of the control valve, and an injector is opened through the pressure-relief of the control valve.

A device of this generic type and a method of this generic type are known. A stroke-controlled device of this kind is particularly useful in connection with a common rail system. In “common rail” accumulator injection, the primary pressure production and the injection are decoupled from each other. The injection pressure is generated independent of the motor speed and injection quantity and is stored in the “rail” (fuel accumulator), ready for the injection. In the injection device (injector), the common rail pressure is supplied by means of a fuel inlet to both the pressure chamber of the injector by means of an inlet conduit and to a control chamber of a control valve by means of an inlet throttle. In the neutral state, an outlet throttle of the control chamber is closed so that the high pressure of the rail builds up in the control chamber. For example, this high pressure can lie in the range between 1000 and 2000 bar. The pressure in the control chamber acts on a plunger rod of the injector so that the injector is held closed. A control valve is actuated to produce the injection. With the use of a solenoid valve as the control valve, this occurs through direct electrical excitation of the solenoid valve. If a piezoelectric actuator is used as an actuating element, then a control valve is actuated by means of a hydraulic pressure intensification. As soon as the control valve unblocks the outlet throttle of the control chamber, this control chamber is pressure-relieved. As a result, the pressure in the control chamber decreases abruptly and so does the force acting on the plunger rod of the injector. The injector can therefore open and an injection can be executed at the pressure prevailing in the pressure chamber, the common rail pressure. In order to close the injector, the outlet throttle of the control chamber is closed so that the common rail pressure builds up again in the control chamber by means of the inlet throttle.

A stroke-controlled system of this kind has turned out to be very reliable. It should be noted, however, that the stroke control takes place at the high common rail pressure. The control chamber and the control valve are consequently subjected to high forces so that the control valve must also be actuated with corresponding forces. Furthermore, a pressure control in opposition with a stroke control or in combination with a stroke control can be advantageous in a certain regard since this has the potential for reducing fuel consumption and pollutant emissions.

### ADVANTAGES OF THE INVENTION

The injection device according to the invention, according to claim 1, has the advantage over the prior art that at least one additional first valve and one additional second valve are provided, that the additional first valve can introduce a primary pressure into a pressure chamber of the injector and into the control chamber, that the additional second valve can connect the pressure chamber of the injector and the control chamber to a leakage system, and that the control valve, the additional first valve, and the additional second valve can be actuated by the same actuating element. In this manner, it is possible to advantageously combine a stroke control with a pressure control and to reduce the forces acting on the control valve. If the actuating element is actuated in stages, then it is possible to carry out a conventional stroke control of the injector. With a complete interconnection of the valve system, which still depends on the sequence of the individual valve switching actions, the system can operate in an essentially pressure-controlled manner.

Preferably, the actuating element is a piezoelectric actuator. Piezoelectric actuators have proven successful as electronically activated actuating elements, particularly since they are compact in design and reliable in function. Furthermore, the actuating function can be changed by altering the parameters (voltage, pulse duration) of the activation.

Preferably, the actuating element actuates the control valve, the additional first valve, and the additional second valve by means of a hydraulic pressure intensifier. Particularly with the use of a piezoelectric actuator, this is useful for producing a sufficient stroke for the actuation of the valves.

It is advantageous if the control valve and the additional first valve are embodied as 2/2-port directional-control valves. In the additional first valve, the first connection can be used for the fuel inlet and the second connection can be used for the supply line to the control chamber and the injector. In a first switched state, the fuel inlet from the control chamber and the pressure chamber of the injector is decoupled, while in a second switched state, there is a coupling. The control valve can be coupled to the control chamber via a connection and an outlet throttle. The other connection leads to a leakage system. In a first switched state, the control chamber is decoupled from the leakage system. In a second switched state, they are coupled.

Preferably, the additional second valve is embodied as a 2/2-port directional-control valve. As a result, the first connection of the additional second valve can be coupled to the pressure chamber of the injector and the control chamber. The second connection leads to a leakage system. In the open, first switched state of the additional second valve, the pressure chamber of the injector and the control chamber are connected to the leakage system. In the second, closed switched state of the additional second valve, the pressure chamber of the injector and the control chamber are decoupled from the leakage system.

It can also be useful if the additional second valve is embodied as a 3/2-port directional-control valve. Through the additional connection of the additional second valve, it is possible to route the connection of the control valve to the leakage system through the additional second valve. This can be advantageous in terms of design.

Preferably the control valve is a ball valve. The use of a ball valve as the control valve has already proven useful in injectors, which operate with a solenoid valve as the control valve. These proven valve properties can be used within the scope of the invention.

It is advantageous if the additional first valve and the additional second valve can be directly actuated by the actuating element via a bridge and if the control valve can be indirectly actuated by the actuating element via the bridge. In this way, the switching actions of the individual valves can be influenced differently during the activation of the actuating element. This relates, for example, to both the switching time and the forces required for the switching.

Preferably, the indirect actuation of the control valve takes place via a diaphragm or a sealed spring, whereby the advantages of indirect actuation can be realized.

It is particularly preferable if the indirect actuation of the control valve is accompanied by a force-to-path translation. It is therefore possible to actuate the control valve with a lower force than the additional first valve and the additional second valve. Therefore, the occasionally reduced pressure in the control chamber of the control valve is taken into account.

Preferably, the control valve, the additional first valve, and the additional second valve are disposed so that with an actuation of the actuating element, first the additional second valve closes, then the additional first valve opens, and then the control valve opens. Through the closing of the additional second valve, the pressure chamber of the injector and the control chamber are decoupled from the leakage system. If the additional second valve is subsequently opened, then a pressure increase in the injection device is therefore possible. This pressure increase can produce a pressure-controlled opening of the injector. However, the triggering of the actuating element can also take place so that first, a sufficient pressure builds up in the control chamber of the control valve and the subsequent opening of the control valve produces a stroke-controlled opening of the injector. All combinations of the above-described pressure control with the above-described stroke control are conceivable.

Preferably, the primary pressure is supplied by a common rail. It is consequently possible to combine the advantages of a common rail system not only with the pressure control but also with the stroke control, as well as with combinations of them.

According to claim 13, the method according to the invention is based on the prior art in that through activation of the actuating element, at least one additional first valve and one additional second valve are actuated, that through the actuation of the additional second valve, a pressure chamber of the injector and the control chamber are closed off from the leakage system, and that through the actuation of the additional first valve, a primary pressure is supplied to the pressure chamber of the injector and to the control chamber. In this manner, it is possible to supply a system, which is pressure-relieved at first, with a primary pressure through the opening of the additional first valve and to execute both a stroke control and a pressure control of the injector. Furthermore, the control valve can be advantageously operated with low actuating forces.

In this method, the force of the actuating element is preferably hydraulically intensified. This permits a sufficient stroke to be produced for actuation of the valves.

It is advantageous if, through activation of the actuating element, first the additional second valve is closed, then the additional first valve is opens, and then the control valve is opened. In the starting position, the additional second valve is consequently closed so that the pressure chamber of the injector and the control chamber are pressure-relieved. The additional second valve is then closed so that through the opening of the additional first valve, a pressure can build up in the injection system. Depending on the execution of the individual switching actions, this produces a pressure-controlled opening of the injector or produces a stroke control. A stroke control is executed by opening the control valve after the opening of the first additional valve. Consequently, the advantages of a pressure control can be combined with those of a stroke control.

Preferably, the additional first valve and the additional second valve are directly actuated via a bridge and the control valve is indirectly actuated via the bridge. In this manner, it is possible on the one hand to actuate the valves with a single actuating element. On the other hand, the valve actuation can be executed in a differentiated fashion through the direct and indirect actuation.

Preferably, the control valve is actuated by means of a diaphragm or a sealed spring. This permits the indirect actuation to be achieved in a simple manner.

It is preferable that in the indirect actuation of the control valve, the force exerted by the bridge is intensified. In so doing, the fact that the control valve can be actuated with less intense forces is taken into account.

The invention is based on the surprising discovery that providing the claimed valve device permits a pressure control to be advantageously combined with a stroke control. It is also possible to switch to the control valve with less intense forces. As a result of the reduced forces, the piezoelectric actuator can be selected to be comparatively small in size, which is conducive to a compact design of the injection system. This compact design is also promoted by the fact that the valves are actuated by a single actuating element.

### DRAWING

The invention will now be explained by way of example through a particular embodiment with reference to the drawing.

FIG. 1 shows an injection device according to the invention.

### DESCRIPTION OF THE EXEMPLARY EMBODIMENT

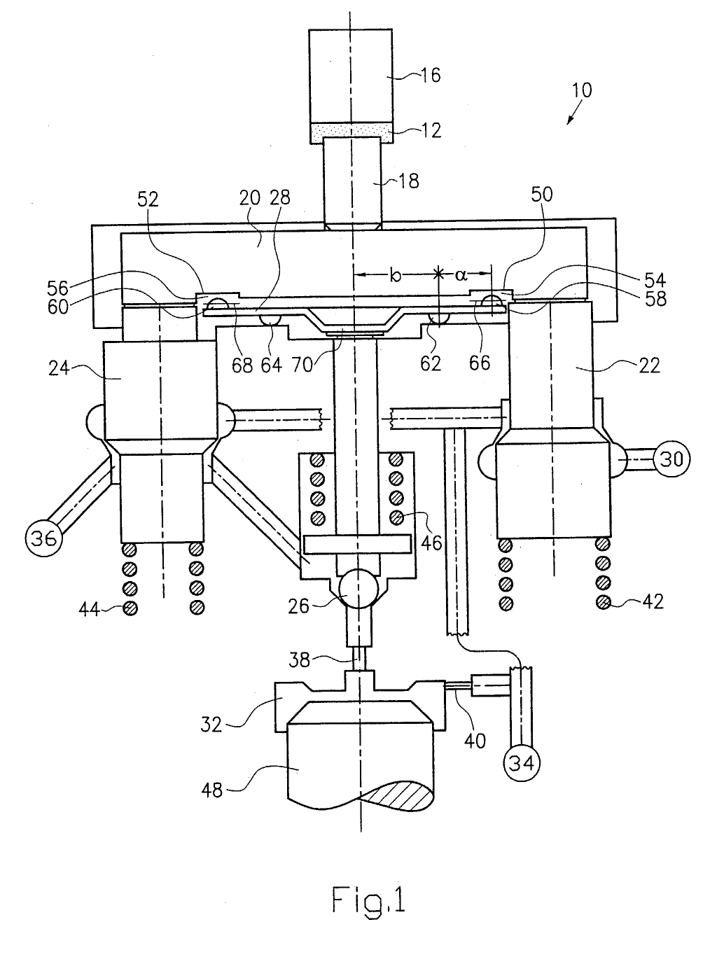

FIG. 1 shows an embodiment of an injection device 10 according to the invention. An actuating element 14 (not shown) exerts force on a hydraulic pressure intensifier 12. The hydraulic pressure intensifier 12 includes a first intensifier piston 16 and a second intensifier piston 18. The second intensifier piston 18 exerts a force on a bridge 20. The bridge in turn exerts a force directly on a first valve 22 and a second valve 24. The bridge 20 actuates a control valve 26 indirectly by means of a diaphragm 28. In the current instance, the first valve 22 is embodied as a 2/2-port directional-control valve and its connections are attached on the one hand to the common rail inlet 30 and on the other hand to a control chamber 32 and to the pressure chamber 34 of an injector. The control chamber 32 is defined on one side by a plunger rod 48, which leads to the injector. In this instance, the second valve 24 is embodied as a 3/2-port directional-control valve. It is also connected on the one hand to the pressure chamber 34 of the injector and to the control chamber 32. A second connection leads to the leakage system 36. A third connection, which corresponds to the second connection in terms of its technical switching characteristics, connects the second valve 24 to a connection of the control valve 26. The other connection of the control valve 26 is connected to the control chamber 32 via an outlet throttle 38. An inlet throttle 40 is provided in the inlet to the control chamber 32. The injection device is shown in a state in which all of the valves 22, 24, 26 are closed. Springs 42, 44, 46 exert force on the respective valves in order to permit them to return to the starting position when the actuating element 14 is shortened.

An injection method can be described as follows. Initially, the actuating element 14 is completely retracted. In this instance, the first valve 22 is closed, the second valve 24 is open, and the control valve 26 is closed. Consequently, the common rail pressure from the common rail 30 is not introduced into the system. Instead, the pressure chamber 34 of the injector and the control chamber 32 can be pressure-relieved. A definite position of the plunger rod 48 in this state is assured, for example, by elastic means (not shown). If the actuating element 14 is extended, then a force is exerted on the bridge 20 by means of the hydraulic pressure intensifier 12 and the intensifier pistons 16, 18. This causes the bridge 20 to be slid downward and initially actuates the valves 22, 24. The second valve 24 closes and the first valve 22 opens. Consequently, the common rail pressure builds up in the injection system, particularly in the pressure chamber 34 of the injector and in the control chamber 32, in particular since the control valve 26 is still closed.

The control valve 26 is opened only after further extension of the actuating element 14. If the bridge 20 moves further downward, then at a particular time, the top surfaces 50, 52 of two air gaps 54, 56 come into contact with respective stops 58, 60. Starting from this time, a force initially exerted by the actuating element 14 acts on the diaphragm 28. On its underside, the diaphragm 28 is supported on deflecting elements 62, 64. If the bridge 20 has exceeded a certain stroke, which is indicated by the lines 66, 68, then the force, which is exerted on the control valve 26 by the middle part 70 of diaphragm, has decreased to the point that the control valve 26 can open. The necessary reduction of the force exerted on the control valve 26 by the middle part 70 depends on the pressure prevailing in the control chamber 32.

In terms of the method, two extreme cases can now be considered. On the one hand, the actuating element 14 and consequently the bridge 20 can actuate the valves in stages. For example, the relative actuation of the valves can be designed so that when the valve 22 is open, the control chamber is first brought to the common rail pressure and only then, by means of a conventional stroke control, does the injector open due to the opening of the control valve 26. In another extreme case, the pressure in the pressure chamber can increase so rapidly that a pressure-controlled opening of the injector occurs. Between these extreme cases, any combination of a pressure control and a stroke control is conceivable.

In a preferred case, since a pressure prevailing in the control chamber 32 is lower than the common rail pressure, only a reduced force acts on the ball of the control valve 26. As a result, the middle part 70 of the diaphragm 28 only has to exert a comparatively slight opposing force in order to hold the control valve closed. Correspondingly, the intensification segments a, b that are shown can be selected, which depend on force transmission points of the diaphragm 28. Since the control valve is actuated with a reduced force, an actuating element 14 with smaller dimensions overall can be used.

The above description of exemplary embodiments according to the current invention is intended merely for illustrative purposes and not to limit the invention. Various changes and modifications are possible without going beyond the scope of the invention and its equivalents.

1. An injection device with an injector, a control valve (26) for opening and closing the injector by means of a control chamber (32), and an actuating element (14) for actuating the control valve (26), characterized in that at least one additional first valve (22) and one additional second valve (24) are provided, that the additional first valve (22) can introduce a primary pressure into a pressure chamber (34) of the injector and into the control chamber (32), that the additional second valve (24) can connect the pressure chamber (34) of the injector and the control chamber (32) to a leakage system (36), and that the control valve (26), the additional first valve (22), and the additional second valve (24) can be actuated by the same actuating element (14).

2. The injection device according to claim 1, characterized in that the actuating element (14) is a piezoelectric actuator.

3. The injection device according to claim 1 or 2, characterized in that the actuating element (14) actuates the control valve (26), the additional first valve (22), and the additional second valve (24) by means of a hydraulic pressure intensifier (12).

4. The injection device according to one of the preceding claims, characterized in that the control valve (26) and the additional first valve (22) are embodied as 2/2-port directional-control valves.

5. The injection device according to one of the preceding claims, characterized in that the additional second valve (24) is embodied as a 2/2-port directional-control valve.

6. The injection device according to one of claims 1 to 4, characterized in that the additional second valve is embodied as a 3/2-port directional-control valve.

7. The injection device according to one of the preceding claims, characterized in that the control valve (26) is a ball valve.

8. The injection device according to one of the preceding claims, characterized in that the additional first valve (22) and the additional second valve (24) can be directly actuated by the actuating element (14) via a bridge (20) and that the control valve (26) can be indirectly actuated by the actuating element (14) via the bridge (20).

9. The injection device according to claim 8, characterized in that the indirect actuation of the control valve (26) is executed via a diaphragm (28) or a sealed spring.

10. The injection device according to one of claims 7 to 9, characterized in that the indirect actuation of the control valve (26) is accompanied by a force-to-path translation.

11. The injection device according to one of the preceding claims, characterized in that the control valve (26), the additional first valve (22), and the additional second valve (24) are disposed so that with an actuation of the actuating element (14), first the additional second valve (24) closes, then the additional first valve (22) opens, and then the control valve (26) opens.

12. The injection device according to one of the preceding claims, characterized in that the primary pressure is supplied by a common rail (30).

13. A method for injecting fluid, in which an actuating element (14) is activated, the actuating element (14) actuates a control valve (26), a pressure chamber (32) is pressure-relieved through the actuation of the control valve (26), and the pressure-relief of the control valve causes an injector to open, characterized in that through the activation of the actuating element (14), at least one additional first valve (22) and one additional second valve (24) are actuated, that the actuation of the additional second valve (24) closes a pressure chamber (34) of the injector and the control chamber (32) off from a leakage system (36), and that the actuation of the additional first valve (22) introduces a primary pressure into the pressure chamber (34) of the injector and into the control chamber (32).

14. The method according to claim 13, characterized in that the force of the actuating element (14) is hydraulically intensified.

15. The method according to claim 13 or 14, characterized in that through the activation of the actuating element (14), first the additional second valve (22) is closed, then the additional first valve (22) is opened, and then the control valve (26) is opened.

16. The method according to one of claims 13 to 15, characterized in that the additional first valve (22) and the additional second valve (24) are directly actuated via a bridge (20) and that the control valve (26) is indirectly actuated via the bridge (20) and a diaphragm (28) or a sealed spring.

17. The method according to one of claims 13 to 16, characterized in that the force exerted by the bridge (20) is intensified in the indirect actuation of the control valve (26).
